(19) United States
(12) Patent Application Publication
(10) Pub. No.: US 2023/0407629 A9
(43) Pub. Date: Dec. 21, 2023

(54) Partition Apparatus

(71) Applicant: R.A.S. Developments, LLC, Washington, DC (US)

(72) Inventor: Russell Adams Sears, Washington, DC (US)

(21) Appl. No.: 17/360,771

(22) Filed: Jun. 28, 2021

Related U.S. Application Data
(63) Continuation-in-part of application No. 29/746,084, filed on Aug. 11, 2020, now Pat. No. D931655.
(60) Provisional application No. 63/055,796, filed on Jul. 23, 2020.

(51) Int. Cl. E04B 2/74; F16M 11/22; F16M 11/42; F16M 11/04; F16B 5/06

(52) U.S. Cl. CPC E04B 2/7405; F16M 11/22; F16M 11/42; F16M 11/043; F16B 5/06

(57) ABSTRACT

The present invention is a partition apparatus suited for distancing and separating users from each other while keeping visual connectivity. The partition apparatus contains at least one partition receiver and at least one partition barrier. Each of the at least one partition receiver contains a fastener element. Each of the at least one partition barrier is connected adjacent to each of the at least one partition receiver through the fastener element.

The current application is a continuation-in-part (CIP) application of the U.S. design application Ser. No. 29/746,064 filed on Aug. 11, 2020.

The current application also claims a priority to the U.S. Provisional Patent application Ser. No. 63/055,796 filed on Jul. 23, 2020.

### FIELD OF THE INVENTION

The present invention relates generally to a partition apparatus, specifically a protective partition apparatus that can prevent the spread of bacteria or virus containing droplets while maintaining proximity and visual connectivity between people.

### BACKGROUND OF THE INVENTION

The wide-spread outbreaks of infectious respiratory illnesses (e.g., “COVID-19”, which stands for coronavirus disease 2019) may lead to significant changes in living, educational, and working patterns. COVID-19 spreads mainly among people who are in close contact (within about 6 feet) for a prolonged period. Spread happens when an infected person coughs, sneezes, or talks, and droplets from their mouth or nose are launched into the air and land in the mouths or noses of people nearby. Therefore, the government has introduced multiple measures, such as social distancing, in order to control the coronavirus outbreak and equally could apply to any other airborne virus/bacteria transmission outbreak.

Social distancing, also called “physical distancing”, is a set of non-pharmaceutical interventions or measures intended to prevent the spread of a contagious disease by maintaining a physical distance between people and reducing the number of times people come into close contact with each other. At the height of the pandemic, the Centers for Disease Control and Prevention (CDC) suggested that a person should stay at least 6 feet (about 2 arms' length) from other people in both indoor and outdoor spaces.

For a restaurant and a bar, social distancing usually means that the table/stool/floor layout of the restaurant needs to be changed to reduce seating capacity so as to allow tables and stools to be spaced at least 6 feet apart. Therefore, it is very difficult for the restaurant/bar to make a profit at this reduced seating capacity.

For a school, social distancing usually means that the desk/floor layout of the classroom needs to be changed to reduce seating capacity to allow desks to be spaced at least 3 to 6 feet apart. Therefore, it is exceedingly difficult for a classroom to accommodate its pre-Covid 19 student capacity and would either create a need to reduce classroom capacity, stagger student attendance or add more classroom spaces.

The present invention aims to solve some of these problems by disclosing a partition apparatus that can keep the original table/desk/stool/floor layout of the restaurant/bar/school while preventing the transfer of viral contagions. The present invention is a partition apparatus mainly designed for restaurants and schools. However, it should be noted that the present invention can in fact be placed at any desired location, including but not limited to open office plan layouts, cubicles, side by side checkout counters/payment counters, doctors' offices, etc. Moreover, the partition apparatus can take a variety of forms based on specific applications and requirements. The present invention is simple in structure, inexpensive to manufacture, and easy to use, relocate, move or slide. The present invention can also be repurposed for different uses besides the use of transparent panels. These panels can be replaced with retail panels for merchandise display, mesh panels for live green walls, virtual barrier panels, sound attenuations panels, graphic advertising panels, or any other suitable panels for many applications.

### SUMMARY OF THE INVENTION

The present invention is a partition apparatus suited for distancing and separating users from each other while keeping visual connectivity. The partition apparatus comprises at least one partition receiver, and at least one partition barrier. Each of the at least one partition receiver comprises a fastener element. Each of the at least one partition barrier is connected adjacent to each of the at least one partition receiver through the fastener element.

### BRIEF DESCRIPTION OF THE DRAWINGS

FIG. 1 is a diagram view of the present invention deployed along a bench.

FIG. 2 is a diagram view of the present invention showing various embodiments 2A-2F.

FIG. 3 is a diagram view of the present invention deployed along a bar top.

FIG. 4 is a detailed view of the present invention of circle A in FIG. 3.

FIG. 5 is a side view of the present invention deployed along a plurality of classroom desks.

FIG. 6 is a perspective view of the present invention for classroom desk separation.

FIG. 7 a topside view of the present invention showing various embodiments deployed along a restaurant layout.

FIG. 8 a side view of the present invention deployed along a fastfood order counter.

FIG. 9 a topside view of the present invention deployed along a plurality of classroom desks.

FIG. 10 a topside view of the present invention deployed along a classroom layout.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced or utilized without the implementation of some features as they are described. It should be understood that some details have not been described in detail in order to not unnecessarily obscure focus of the invention. References herein to “the preferred embodiment”, “one embodiment”, “some embodiments”, or “alternative embodiments” should be considered to be illustrating aspects of the present invention that may potentially vary in some instances, and should not be considered to be limiting to the scope of the present invention as a whole.

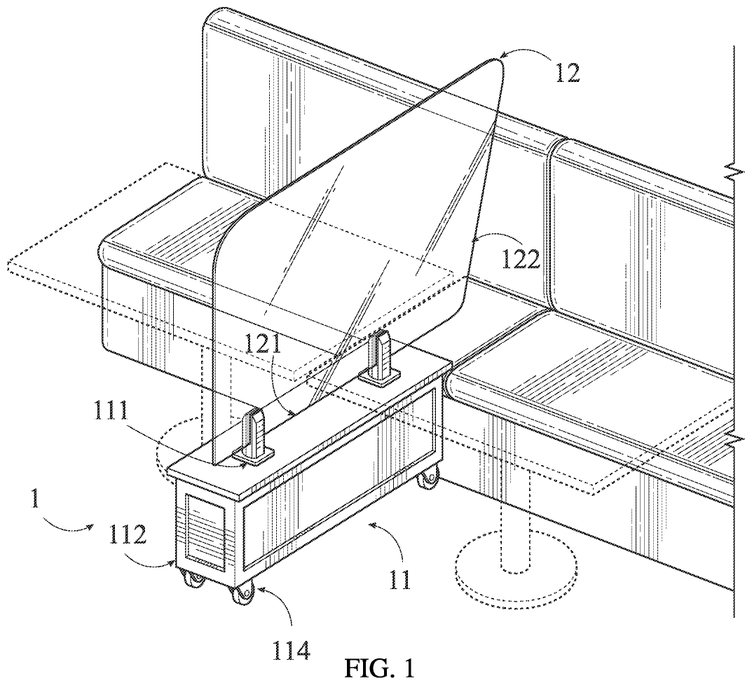

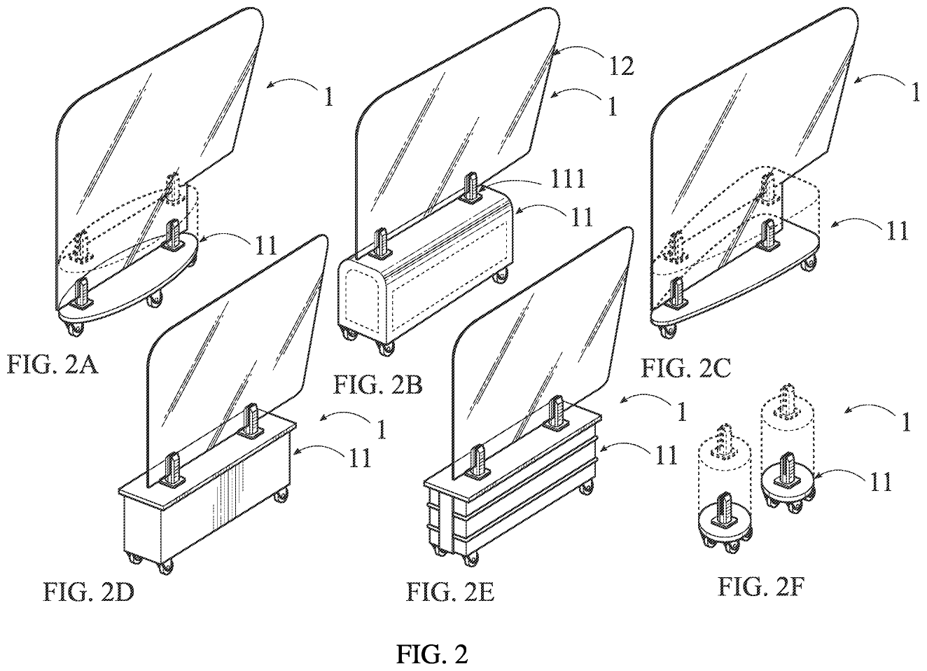

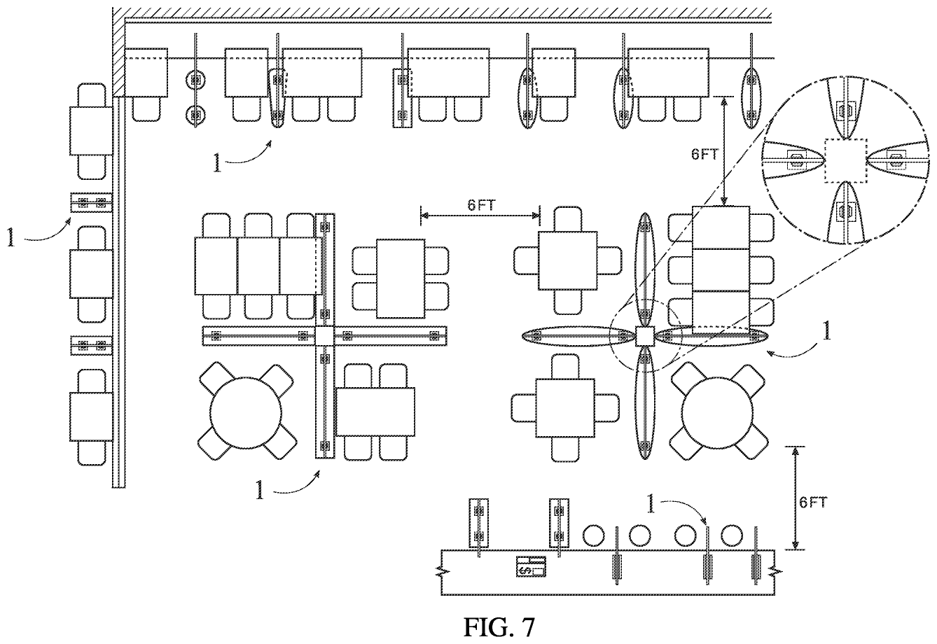

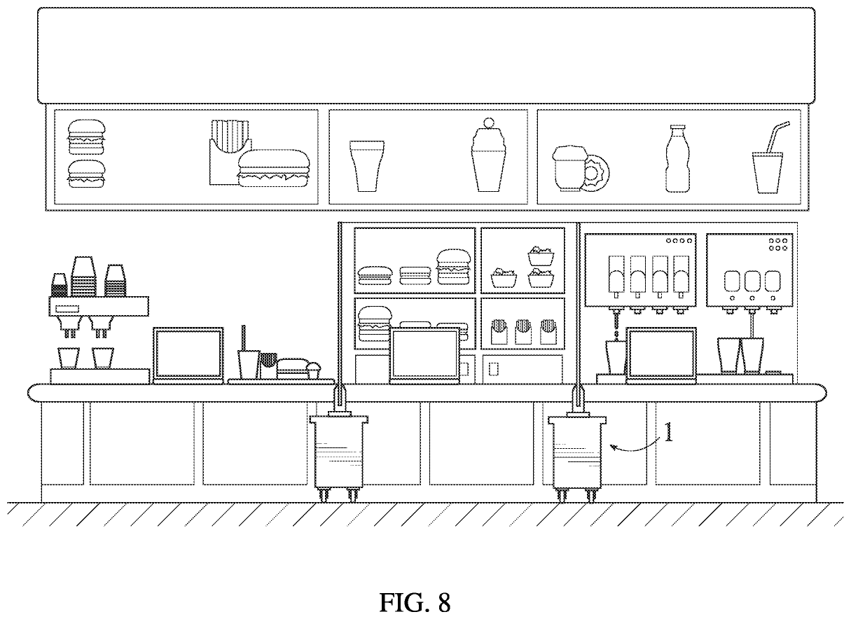

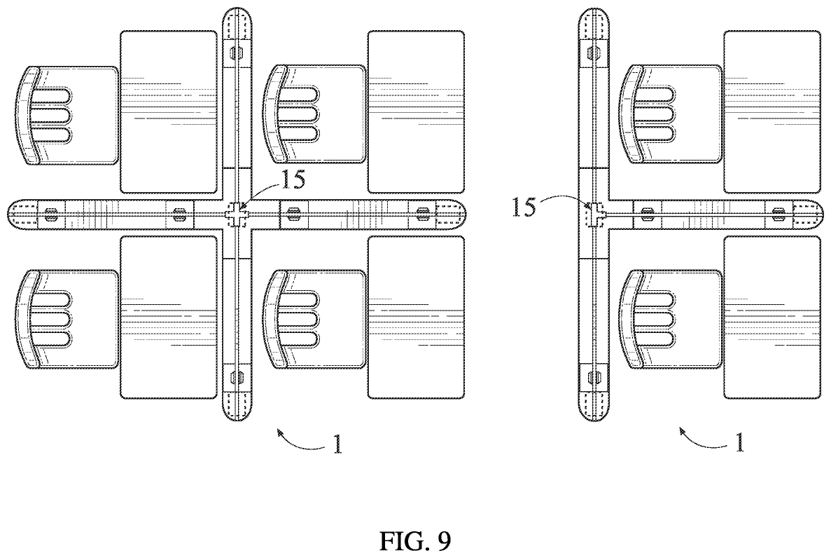

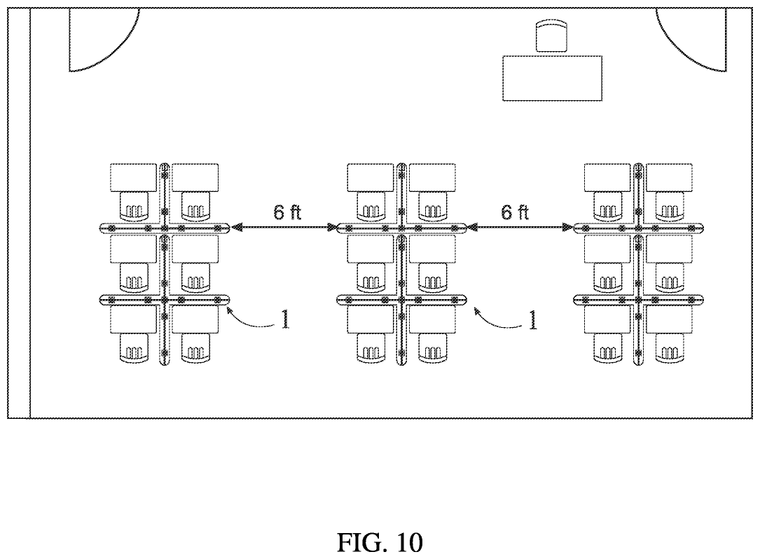

In reference to FIGS. 1-3 and 5-10, the present invention is a partition apparatus 1 that can be placed at the desired location to reduce or eliminate the distance required by social distancing, as shown in FIGS. 7-10. The partition apparatus 1 comprises at least one partition receiver 11 and at least one partition barrier 12. Each of the at least one partition receiver 11 comprises at least one fastener element 111. Each of the at least one partition barrier 12 is connected adjacent to each of the at least one partition receiver 11 through the at least one fastener element 111. In the preferred embodiment of the present invention, the at least one partition receiver 11 is a box style partition receiver, as shown in FIGS. 2B, 2D, and 2E. In another embodiment of the present invention, the at least one partition receiver 11 is a flat style elliptical partition receiver, as shown in FIG. 2A. In another embodiment of the present invention, the at least one partition receiver 11 is a triangular style partition receiver, as shown in FIG. 2C. In another embodiment of the present invention, the at least one partition receiver 11 is a set of cylindrical style partition receivers, as shown in FIG. 2F. In the preferred embodiment of the present invention, the at least one partition receiver 11 is secured along a suitable flat surface, such that the at least one partition receiver 11 props up the at least one partition barrier 12 in a vertical orientation. In the preferred embodiment of the present invention, the at least one partition receiver 11 is made out of any suitable material, such as, but not limited to polymer, aluminum, wood, sheet metal, solid metal, stainless steel, or any other suitable material. In the preferred embodiment of the present invention, the at least one partition barrier 12 may take the form of a glass shield suitable for sanitary partitioning in social settings while maintaining visual connectivity. In various embodiments, the at least one partition barrier 12 may take the form of any suitable barrier, such as, but not limited to solid panels, perforated panels, slatted panels, shelving units, wire screens, green walls, sound barriers, test-taking barriers, signs, or any other suitable type of barrier implement. In the preferred embodiment of the present invention, the at least one fastener element 111 may take the form of a clamp type at least one fastener element 111 that mounts the partition barrier along the partition receiver. In various embodiments, the at least one fastener element 111 may take the form of any suitable fastener, such as, but not limited to threaded connectors, vice connectors, or any other suitable fastener implement.

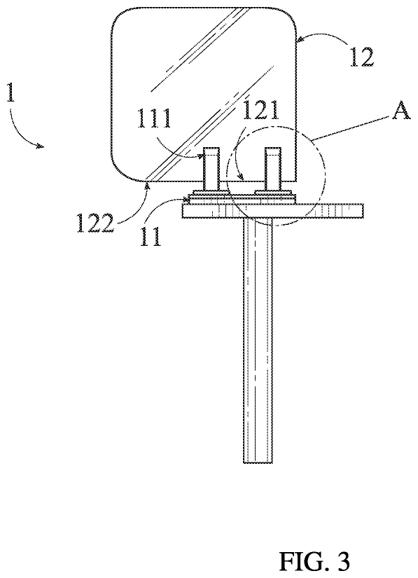

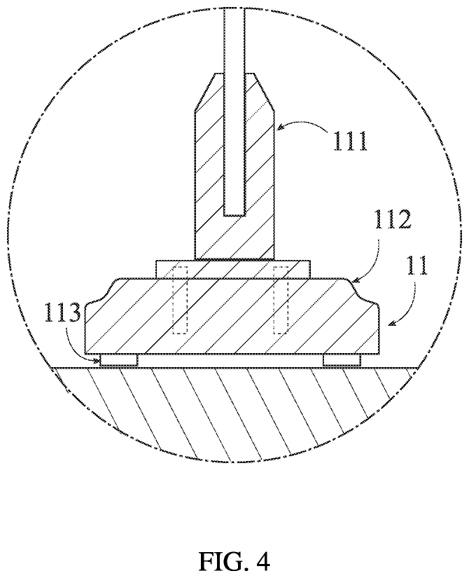

In reference to FIGS. 3-4, each of the at least one partition receiver 11 comprises a partition base 112 and at least one mounting element 113. The at least one mounting element 113 is connected adjacent to the partition base 112, opposite to the at least one fastener element 111. In the preferred embodiment of the present invention, the partition base 112 may take the form of a weighted base that aids in anchoring the at least one partition receiver 11 to the flat surface it is oriented on, preventing the at least one partition barrier 12 from toppling over. In the preferred embodiment of the present invention, the at least one mounting element 113 facilitates further securement along the flat surface the at least one partition receiver 11 is oriented on. In the preferred embodiment of the present invention, the at least one mounting element 113 may take the form of felt pads that will enable the at least one partition receiver 11 to slide along a flat surface allowing the at least one partition receiver 11 to reposition in any location. In various embodiment, the at least one mounting element 113 may take the form of any other suitable mounting implement, such as, but not limited to rubber pads, suction cups, magnets, sliders, or any other suitable mounting implement.

In another embodiment, each of the at least one partition receiver 11 comprises a partition base 112 and at least one caster 114, as shown in FIGS. 1 and 5-6. The at least one caster 114 is connected adjacent to the partition base 112, opposite to the at least one fastener element 111. In this embodiment, the at least one caster 114 allows the partition apparatus 1 to roll along the flat surface, making the partition apparatus 1 easier to move and handle.

In the preferred embodiment of the present invention, each of the at least one partition barrier 12 is slidably connected to each of the at least one partition receiver 11 through the at least one fastener element 111. This allows the at least one partition barrier 12 to adjust in any orientation along the at least one receiver.

In reference to FIGS. 1 and 3, each of the at least one partition barrier 12 comprises a mounting portion 121 and an overhanging portion 122. The mounting portion 121 is positioned adjacent to the overhanging portion 122. Each of the at least one partition receiver 11 is distributed about the mounting portion 121. In the preferred embodiment of the present invention, the overhanging portion 122 of the at least one partition barrier 12 covered elevated spaces that would normally obstruct along the at least one partition receiver 11. In one instance, the overhanging portion 122 covers the space obstructed by a bench or bar counter allowing for means of separation between users situated along the bench or bar counter, as shown in FIGS. 1 and 3.

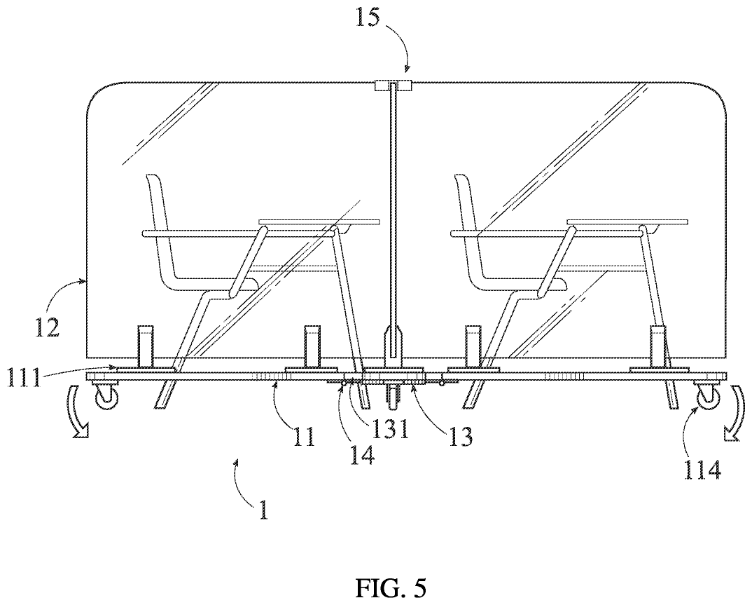

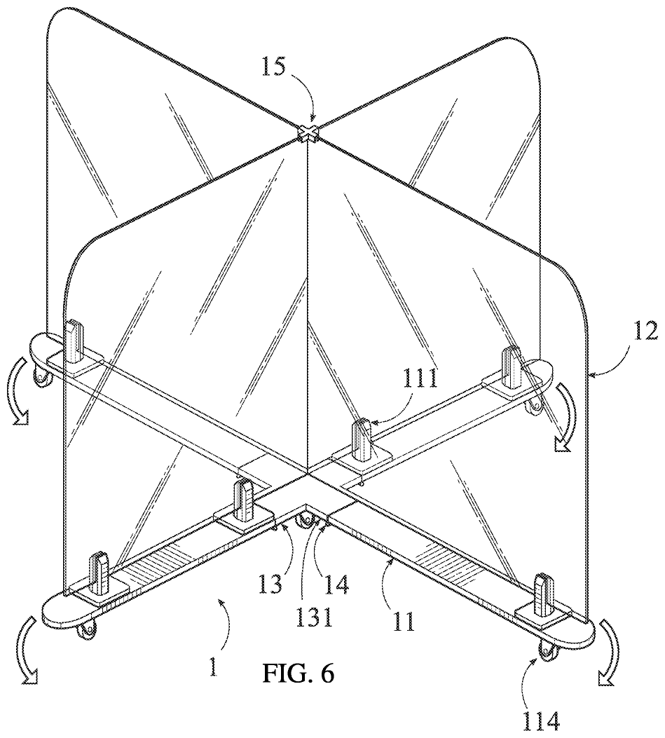

In another embodiment, the partition apparatus 1 further comprises a joint body 13, as shown in FIGS. 5-6. The joint body 13 comprises at least one partition connector 131, as shown in FIGS. 5-6. The at least one partition connector 131 is perimetrically distributed about the joint body 13. Each of the at least one partition receiver 11 is connected to each of the at least one partition connector 131. In this embodiment, the partition apparatus 1 may take the form of a multidimensional partition apparatus 1 that facilitates multiple sides suited for classroom or restaurant environments, as shown in FIGS. 7, 9, and 10. The partition apparatus 1 further comprises a coupling element 15, as shown in FIGS. 5-6 and 9. The at least one partition barrier 12 is connected to each other through the coupling element 15. The coupling element 15 may take the form of a connecting bracket that secures the at least one partition barrier together such that the at least one partition barrier 12 does not separate or sway. Each of the at least one partition receiver 11 is hingedly connected to each of the at least one partition connector 131 through a hinge fastener 14. This allows each of the at least one partition receiver 11 to prop up along the joint body 13 and transform into a configuration suitable for storage.

Although the invention has been explained in relation to its preferred embodiment, it is to be understood that many other possible modifications and variations can be made without departing from the spirit and scope of the invention as hereinafter claimed.

What is claimed is:

1. A partition apparatus comprising:
at least one partition receiver;
at least one partition barrier;
each of the at least one partition receiver comprising at least one fastener element; and
each of the at least one partition barrier being connected adjacent to each of the at least one partition receiver through the at least one fastener element.

2. The partition apparatus as claimed in claim 1 comprising:
each of the at least one partition receiver comprising a partition base and at least one mounting element; and
the at least one mounting element being connected adjacent to the partition base, opposite to the at least one fastener element.

3. The partition apparatus as claimed in claim 1 comprising:
each of the at least one partition receiver comprising a partition base and at least one caster;
the at least one caster being connected adjacent to the partition base, opposite to the at least one fastener element.

4. The partition apparatus as claimed in claim 1 comprising:
each of the at least one partition barrier being slidably connected to each of the at least one partition receiver through the at least one fastener element.

5. The partition apparatus as claimed in claim 1 comprising:
each of the at least one partition barrier comprising a mounting portion and an overhanging portion;
the mounting portion being positioned adjacent to the overhanging portion; and
each of the at least one partition receiver being distributed about the mounting portion.

6. The partition apparatus as claimed in claim 1 comprising:
a joint body;
the joint body comprising at least one partition connector;
the at least one partition connector being perimetrically distributed about the joint body; and
each of the at least one partition receiver being connected to each of the at least one partition connector.

7. The partition apparatus as claimed in claim 6 comprising:
a coupling element; and
the at least one partition barrier being connected to each other through the coupling element.

8. The partition apparatus as claimed in claim 6 comprising:
each of the at least one partition receiver being hingedly connected to each of the at least one partition connector through a hinge fastener.

9. The partition apparatus as claimed in claim 1, wherein the at least one partition receiver is a box style partition receiver.

10. The partition apparatus as claimed in claim 1, wherein the at least one partition receiver is a flat style partition receiver.

11. The partition apparatus as claimed in claim 1, wherein the at least one partition receiver is a triangular style partition receiver.

12. The partition apparatus as claimed in claim 1, wherein the at least one partition receiver is a set of cylindrical style partition receivers.
